(19) United States
(12) Patent Application Publication
(10) Pub. No.: US 2015/0055066 A1
(43) Pub. Date: Feb. 26, 2015

(54) THIN FILM TRANSISTOR SUBSTRATE, METHOD OF MANUFACTURING THE SAME, AND DISPLAY DEVICE INCLUDING THE SAME

(71) Applicant: Samsung Display Co., Ltd., Yongin-City (KR)

(72) Inventors: SungHoon YANG, Seoul (KR); JEANHO SONG, Yongin-si (KR); Bong-Kyun KIM, Hwaseong-si (KR)

(73) Assignee: Samsung Display Co., Ltd., Yongin-City (KR)

(21) Appl. No.: 14/165,856

(22) Filed: Jan. 28, 2014

(30) Foreign Application Priority Data
Aug. 20, 2013 (KR) 10-2013-0098719

(51) Int. Cl. G02F 1/1335; G02F 1/1368

(52) U.S. Cl. CPC G02F 1/133553; G02F 1/1368
USPC 349/106; 349/113; 438/30; 257/59; 257/72

(57) ABSTRACT

A thin film transistor substrate includes a first substrate which includes a transmissive area and a reflective area, a common electrode disposed on the first substrate, a pixel electrode overlapped with and insulated from the common electrode, and a reflective portion which is disposed on the reflective area and includes a lower electrode which includes a first transparent conductive material, a metal layer disposed on the lower electrode, and an upper electrode disposed on the metal layer and including a second transparent conductive material different from the first transparent conductive material.

This application claims priority to Korean Patent Application No. 10-2013-0098719, filed on Aug. 20, 2013, and all the benefits accruing therefrom under 35 U.S.C. §119, the contents of which are hereby incorporated by reference in its entirety.

### BACKGROUND

1. Field

The invention relates to a thin film transistor (“TFT”) substrate, a method of manufacturing the same, and a display device having the same. More particularly, the invention relates to a transflective TFT substrate, a method of manufacturing the transflective TFT substrate and a display device having the transflective TFT substrate.

2. Description of the Related Art

In recent years, a liquid crystal display (“LCD”) device is most widely used as a flat panel display device. The LCD device includes two substrates and a liquid crystal layer interposed between the two substrates. The LCD device applies an electric field to the liquid crystal layer to realign liquid crystal molecules of the liquid crystal layer, thereby controlling an amount of light passing through the liquid crystal layer.

The LCD device is classified into a vertical electric field mode and a horizontal electric field mode in accordance with the direction of the electric field.

Nowadays, the LCD device operated in the horizontal electric field mode has been mainly developed since the LCD device operated in the vertical electric field mode has a poor viewing angle. In detail, researches to effectively reduce a manufacturing cost of the LCD device operated in the horizontal electric field mode, e.g., a plane-to-line switching mode, have been processed.

Since the LCD device is not self-emissive, the LCD device uses a separate light source. Accordingly, the LCD device further includes a backlight unit disposed at a rear side of a LCD panel, which is configured to include the two substrates and the liquid crystal layer, to provide light to the LCD panel. The light from the backlight unit is incident to the LCD panel and the amount of the light incident to and passing through the LCD panel is controlled in accordance with the alignment of the liquid crystal molecules, thereby displaying a desired image. This type of the LCD device is called a transmission type LCD device. The transmission type LCD device displays bright image under a dark external environment since the transmission type LCD device uses an artificial light source generated by the backlight unit. However, the backlight unit uses high power consumption, and thus the backlight unit is not suitable for mobile display devices.

To solve the above-mentioned disadvantages, a reflection type LCD device that uses an external light without using the backlight unit has been suggested.

Since the reflection type LCD device displays the image using an external natural light or an external artificial light, the power consumption of the LCD device is extremely reduced. Therefore, the reflection type LCD device is mainly used as a display device for the mobile electronic devices, e.g., personal digital assistant, since the power consumption of the reflection type LCD device is relatively smaller than that of the transmission type LCD device.

### SUMMARY

The reflection type liquid crystal display (“LCD”) device is difficult to be operated in a place where no external light exists or the external light is weak even though the power consumption of the reflective type LCD device is low.

In recent years, therefore, a transflective type LCD device that has advantages of the reflection type LCD device and the transmission type LCD device has been suggested.

The invention provides a thin film transistor (“TFT”) substrate capable of reducing a manufacturing cost thereof.

The invention provides a display device having the TFT substrate.

The invention provides a method of manufacturing the TFT substrate to effectively reduce the manufacturing cost of the TFT substrate.

Exemplary embodiments of the inventive concept provide a TFT substrate including a first substrate, a common electrode, a pixel electrode and a reflective portion. The first substrate includes a transmissive area and a reflective area. The common electrode is disposed on the first substrate. The pixel electrode is overlapped with and insulated from the common electrode. The reflective portion is disposed on the reflective area. The reflective portion includes a lower electrode, a metal layer and an upper electrode, which are sequentially stacked one on another. The lower electrode includes a first transparent conductive material and the upper electrode includes a second transparent conductive material different from the first transparent conductive material.

In an exemplary embodiment, the TFT substrate further includes an organic insulating layer. The organic insulating layer is disposed between the first substrate and the reflective portion and between the first substrate and the common electrode. An upper surface of the organic insulating layer has a concavo-concave shape in an area in which the organic insulating layer is overlapped with the reflective area.

In an exemplary embodiment, the first transparent conductive material may include a material including polycrystalline indium tin oxide (“p-ITO”), amorphous indium tin oxide (“a-ITO”), polycrystalline indium zinc oxide (“p-IZO”) or amorphous indium zinc oxide (“a-IZO”), and the second transparent conductive material includes a material including p-ITO, a-TTO, p-IZO or a-IZO except for the one material used to provide the first transparent conductive material.

In an exemplary embodiment, the metal layer may include silver (Ag), aluminum (Al), AlNd, Chromium (Cr), MoW, or an alloy thereof.

Exemplary embodiments of the inventive concept provide a display device including a TFT substrate, an opposite substrate facing the TFT substrate and a liquid crystal layer disposed between the TFT substrate and the opposite substrate. The TFT substrate includes a first substrate that includes a transmissive area and a reflective area, a common electrode disposed on the first substrate, a pixel electrode overlapped with and insulated from the common electrode and a reflective portion disposed on the reflective area. The reflective portion includes a lower electrode that includes a first transparent conductive material, a metal layer disposed on the lower electrode and an upper electrode disposed on the metal layer and including a second transparent conductive material different from the first transparent conductive material.

Exemplary embodiments of the inventive concept provide a method of manufacturing a TFT substrate including providing a first substrate including a transmissive area and a reflective area, disposing an organic insulating layer on the first substrate, disposing a reflective portion and a first electrode on the organic insulating layer using one mask and providing a second electrode insulated from the first electrode.

In an exemplary embodiment, the forming the reflective portion and the first electrode may include depositing a first transparent conductive layer on the organic insulating layer, depositing a metal material layer on the first transparent conductive layer, depositing a second transparent conductive layer on the metal material layer, and patterning the first transparent conductive layer, the metal material layer and the second transparent conductive layer using a halftone mask, a slit mask, or a diffraction mask, which is disposed above on the second transparent conductive layer.

In an exemplary embodiment, the patterning the first transparent conductive layer, the metal material layer, and the second transparent conductive layer may include disposing a photoresist layer on the second transparent conductive layer, exposing and developing the photoresist layer using the halftone mask, the slit mask, or the diffraction mask to provide a first photoresist layer pattern overlapped with the reflective area and a second photoresist layer pattern overlapped with the transmissive area, etching the first transparent conductive layer, the metal material layer, and the second transparent conductive layer, which are exposed by the first and second photoresist layer patterns, with a first etchant using the first and second photoresist layer patterns as masks, removing the second photoresist layer pattern and a portion of the first photoresist layer pattern to provide a third photoresist layer pattern, crystallizing the first transparent conductive layer to provide a crystallization layer, and etching the metal material layer and the second transparent conductive layer, which are exposed by the third photoresist layer pattern, with the first etchant using the third photoresist layer pattern as a mask.

According to the above, the manufacturing cost of the TFT substrate and the display device may be effectively reduced. In addition, the external light may be effectively reflected.

### BRIEF DESCRIPTION OF THE DRAWINGS

The above and other advantages of the invention will become readily apparent by reference to the following detailed description when considered in conjunction with the accompanying drawings, in which:

FIG. 1 is a perspective view showing an exemplary embodiment of a display device including a thin film transistor (“TFT”) substrate according to the invention;

FIG. 2 is a plan view showing an exemplary embodiment of a portion of the TFT substrate according to the invention;

FIG. 3 is a cross-sectional view taken along a line I-I′ shown in FIG. 2;

FIGS. 4A to 4G are cross-sectional views showing an exemplary embodiment of a method of manufacturing a TFT substrate according to the invention;

FIGS. 5A to 5F are cross-sectional views showing another exemplary embodiment of a method of manufacturing a TFT substrate according to the invention; and

FIGS. 6A to 6F are cross-sectional views showing another exemplary embodiment of a method of manufacturing a TFT substrate according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. In an exemplary embodiment, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, the invention will be explained in detail with reference to the accompanying drawings.

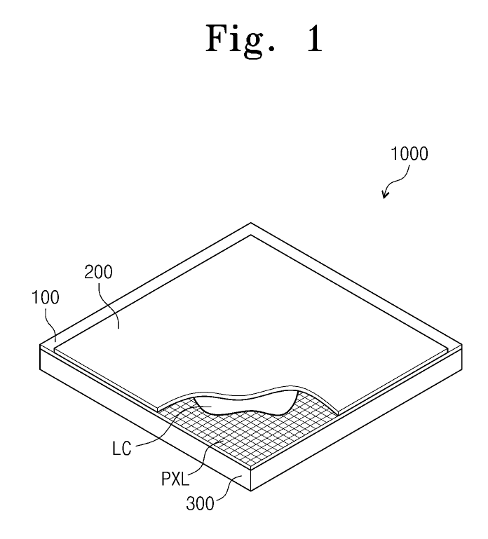

FIG. 1 is a perspective view showing a display device 1000 including a thin film transistor (“TFT”) substrate according to an exemplary embodiment of the invention.

Referring to FIG. 1, the display device 1000 includes a TFT substrate 100 including a plurality of pixels PXL, an opposite substrate 200 facing the TFT substrate 100 and a liquid crystal layer LC disposed between the TFT substrate 100 and the opposite substrate 200.

Each pixel of the TFT substrate 100 includes at least one TFT to drive liquid crystal molecules of the liquid crystal layer LC, a pixel electrode and a common electrode. The opposite substrate 200 may include color filters to display colors of images.

The liquid crystal layer LC includes the liquid crystal molecules having dielectric anisotropy. When an electric field is provided between the pixel electrode and the common electrode, the liquid crystal molecules are rotated in a specific direction between the TFT substrate 100 and the opposite substrate 200. Accordingly, the liquid crystal layer LC controls a transmittance of light incident to and passing through the liquid crystal molecules thereof. A horizontal electric field may be provided in the liquid crystal layer LC by voltages respectively applied to the pixel electrode and the common electrode.

The display device 1000 may further includes a backlight unit 300 disposed under the TFT substrate 100. The backlight unit 300 provides the light to the TFT substrate 100.

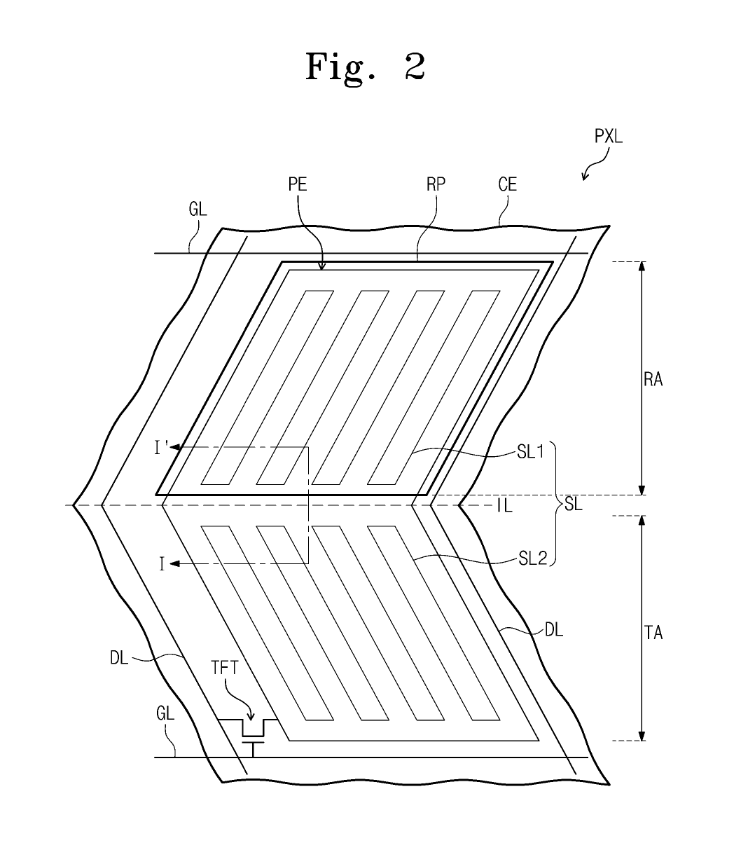

FIG. 2 is a plan view showing a portion of the TFT substrate according to an exemplary embodiment of the invention.

Referring to FIG. 2, the TFT substrate 100 includes a plurality of gate lines, a plurality of data lines and a plurality of pixels. In the exemplary embodiment, since the pixels have the same structure and function, only one pixel PXL of the pixels, two gate lines GL disposed adjacent to one pixel PXL, and two data lines DL disposed adjacent to the one pixel PXL have been shown in FIG. 2.

The gate lines GL cross the data lines DL. The gate lines GL are extended in one direction. The data lines DL include a bent portion between the two gate lines GL adjacent to each other.

Although not shown in figures, a gate insulating layer (not shown) is disposed between the gate lines GL and the data lines DL and the gate lines GL are electrically insulated from the data lines DL by the gate insulating layer (not shown).

The pixel PXL is disposed in an area defined by the gate lines GL and the data lines DL. However, in another exemplary embodiment, the pixel PXL may not be disposed in an area defined by the gate lines GL and the data lines DL.

The pixel PXL includes the TFT, the pixel electrode PE connected to the TFT and the common electrode CE.

The TFT includes a gate electrode (not shown), the gate insulating layer (not shown), a semiconductor pattern (not shown), a source electrode (not shown) and a drain electrode (not shown). The gate electrode may be provided from the gate line GL. The gate insulating layer is disposed on the gate electrode to cover the gate electrode. The gate insulating layer includes an organic insulating material or an inorganic insulating material. The semiconductor pattern faces the gate electrode while interposing the gate insulating layer therebetween. The source electrode is branched from the data line DL. The source electrode is electrically connected to one end of the semiconductor pattern. The drain electrode is disposed to be spaced apart from the source electrode and electrically connected to the other end of the semiconductor pattern. The drain electrode is electrically connected to the pixel electrode PE. When the TFT is turned on in response to a gate signal applied to the gate electrode through the gate line GL, a data voltage applied to the source electrode through the data line DL is applied to the pixel electrode PE through the semiconductor pattern and the drain electrode.

In an exemplary embodiment, the common electrode CE may be integrally provided as a single unitary and individual unit.

The pixel electrode PE is insulated from the common electrode CE and disposed to overlap with the common electrode CE. The pixel electrode PE has a similar outer shape to that of the area defined by the gate lines GL and the data lines DL.

A plurality of slits SL may be defined in the pixel electrode PE. The slits SL are configured to include upper slits SL1 and lower slits SL2, which are distinct by an imaginary line IL substantially in parallel to the gate line GL and crossing a center portion of the pixel electrode PE. The upper slits SL1 are spaced apart from each other in the direction in which the gate lines GL are extended, and each of the upper slits SL1 is extended from an upper right portion toward a lower left portion. In an exemplary embodiment, the lower slits SL2 are spaced apart from each other in the direction in which the gate lines GL are extended, and each of the lower slits SL2 is extended from an upper left portion toward a lower right portion. However, the shapes of the upper and lower slits SL1 and SL2 should not be limited to the above-mentioned shapes. In FIG. 2, four upper slits SL1 and four lower slits SL2 have been shown, but the number of the upper and lower slits SL1 and SL2 should not be limited thereto or thereby.

The pixel PXL includes a transmissive area TA and a reflective area RA. The image provided by the light provided from the backlight unit 300 shown in FIG. 1 is displayed through the transmissive area TA, and the image provided by external light is displayed through the reflective area RA.

The pixel PXL further includes a reflective portion RP disposed in the reflective area RA. The reflective portion RP will be described in detail later.

In an exemplary embodiment, a size of the transmissive area TA and a size of the reflective area RA may be determined depending on a frequency of reflective environment or transmissive environment. In an exemplary embodiment, the size of the reflective area RA may be smaller than that of the transmissive area TA. In the exemplary embodiment, a size ratio of the reflective area RA to the transmissive area TA is 4:6, for example.

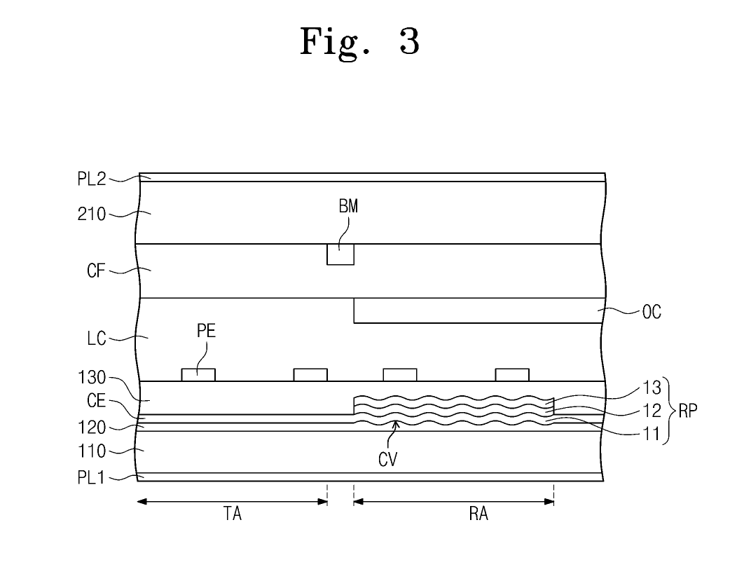

FIG. 3 is a cross-sectional view taken along a line I-I′ shown in FIG. 2.

Referring to FIG. 3, the TFT substrate 100 further includes a first substrate 110, an organic insulating layer 120 and a passivation layer 130.

In an exemplary embodiment, the first substrate 110 may be a transparent insulating substrate. The gate lines GL, the data lines DL and the TFT, which are described with reference to FIG. 2, are disposed between the first substrate 110 and the organic insulating layer 120.

The organic insulating layer 120 is disposed over the entire surface of the first substrate 110.

In an exemplary embodiment, the organic insulating layer 120 has a concavo-convex shape CV on an upper surface thereof in the reflective area RA. Due to the concavo-convex shape CV, a reflective efficiency of the reflective portion RP is improved.

A portion of the organic insulating layer 120, which is not overlapped with the reflective area RA, has a thickness equal to an average thickness of the other portion of the organic insulating layer 120, which is overlapped with the reflective area RA.

The common electrode CE may be disposed on the organic insulating layer 120.

The reflective portion RP is disposed to correspond to the reflective area RA.

The reflective portion RP includes a lower electrode 11, a metal layer 12 and an upper electrode 13.

The lower electrode 11 is disposed on the organic insulating layer 120. The lower electrode 11 is integrally provided with the common electrode CE, is in a same layer as the common electrode CE and includes the same material as the common electrode CE. The lower electrode 11 may be a transparent electrode and include a material including polycrystalline indium tin oxide (“p-ITO”), amorphous indium tin oxide (“a-ITO”), polycrystalline indium zinc oxide (“p-IZO”), or amorphous indium zinc oxide (“a-IZO”). The external light incident to the lower electrode 11 may transmit through the lower electrode 11.

The metal layer 12 is disposed on the lower electrode 11. In an exemplary embodiment, the metal layer 12 includes a metallic material having high reflectance, e.g., silver (Ag), aluminum (Al), AlNd, Chromium (Cr), MoW, or an alloy thereof. In addition, the metal layer 12 has a single-layer structure or a multi-layer structure. The external light incident to the metal layer 12 is reflected by the metal layer 12.

The upper electrode 13 is disposed on the metal layer 12. In an exemplary embodiment, the upper electrode 13 may be a transparent electrode and includes a different material from the lower electrode 11. That is, the upper electrode 13 includes a material including p-ITO, a-ITO, p-IZO, or a-IZO except for the material used to provide the lower electrode 11. The external light incident to the upper electrode 13 may transmit through the upper layer 13.

In an exemplary embodiment the lower electrode 11, the metal layer 12 and the upper electrode 13 may have the concavo-convex shape corresponding to the concavo-convex shape CV of the organic insulating layer 120. The external light incident to the reflective portion RP is reflected by the metal layer 12 and travels toward the outside again. In this case, the external light is diffusively reflected due to the concavo-convex shape of the metal layer 12, and thus the reflective efficiency may be improved.

As described above, since the reflective portion RP has a triple-layer structure of the lower electrode 11, the metal layer 12 and the upper electrode 13, the metal layer 12 may be protected by the lower and upper electrodes 11 and 13.

The passivation layer 130 is disposed on the common electrode CE and the reflection portion RP to cover the common electrode CE and the reflective portion RP.

The pixel electrode PE is disposed on the passivation layer 130.

The opposite substrate 200 (refers to FIG. 1) includes a second substrate 210, a black matrix BM, a color filter layer CF and an overcoating layer OC.

In an exemplary embodiment, the second substrate 210 may be a transparent insulating substrate.

The black matrix BM is disposed on the second substrate 210. The black matrix BM covers an area between the transmission area TA and the reflective area RA. Although not shown in figures, the black matrix BM covers the gate lines GL, the data lines DL and the TFT shown in FIG. 2. The black matrix BM effectively prevents crosstalk from occurring between the transmission area TA and the reflective area RA. In addition, the black matrix BM effectively prevents the gate lines GL, the data lines DL and the TFT from being perceived by the user and the light from leaking.

The color filter layer CF is disposed on the second substrate 210. The color filter layer CF is disposed to correspond to the pixel and assigns a color to the light traveling upward from the second substrate 210 after passing through the liquid crystal layer LC. In an exemplary embodiment, the color filter layer CF includes red, green, blue and white color filters.

The overcoating layer OC is disposed on the color filter layer CF. The overcoating layer OC has a uniform thickness and is overlapped with the reflective area RA. Thus, a cell gap, i.e., a vertical height of the liquid crystal layer LC in a cross section, in the reflective area RA is smaller than a cell gap in the transmission area TA.

Since the external light is incident to the reflective portion RP and reflected by the reflective portion RP to travel to the upper portion of the second substrate 210 in the reflective area RA, an optical path of the external light in the reflective area RA is longer than an optical path of an internal light exiting from the backlight unit 300 and traveling to the upper portion of the second substrate 210.

When the cell gap of the reflective area RA becomes smaller than that of the transmission area TA due to the overcoating layer OC, a difference in the optical path between the transmission area TA and the reflective area RA may be compensated.

The display device 1000 may further include a first polarizing plate PL1 and a second polarizing plate PL2. The first polarizing plate PL1 is disposed under the TFT substrate 100 and the second polarizing plate PL2 is disposed on the opposite substrate 200. In an exemplary embodiment, the first polarizing plate PL1 has a polarizing axis substantially perpendicular to a polarizing axis of the second polarizing plate PL2.

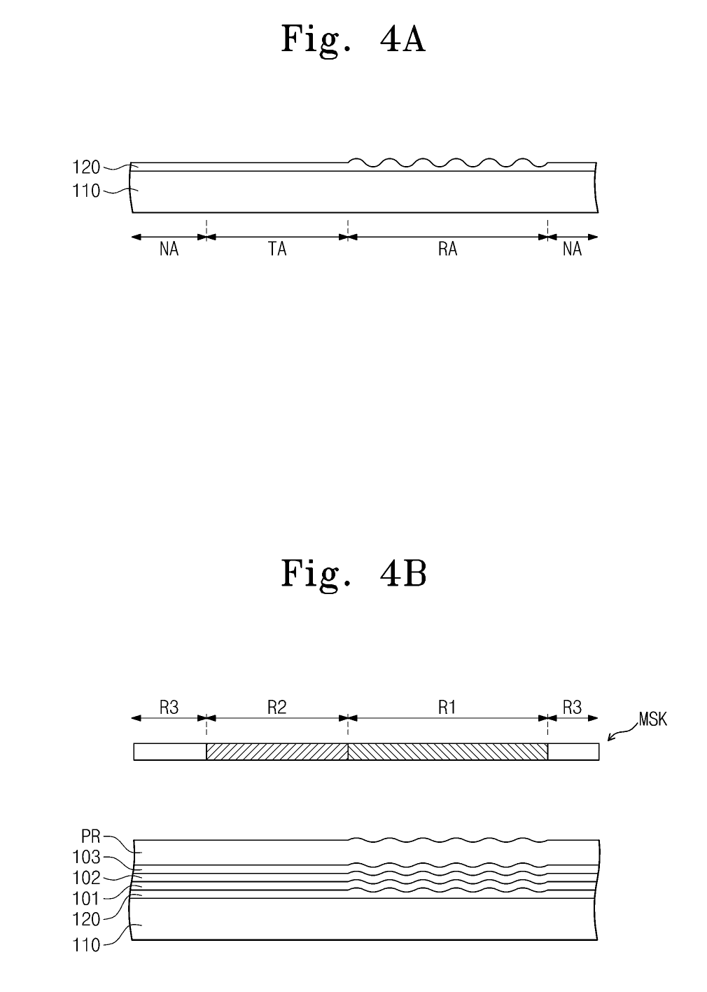

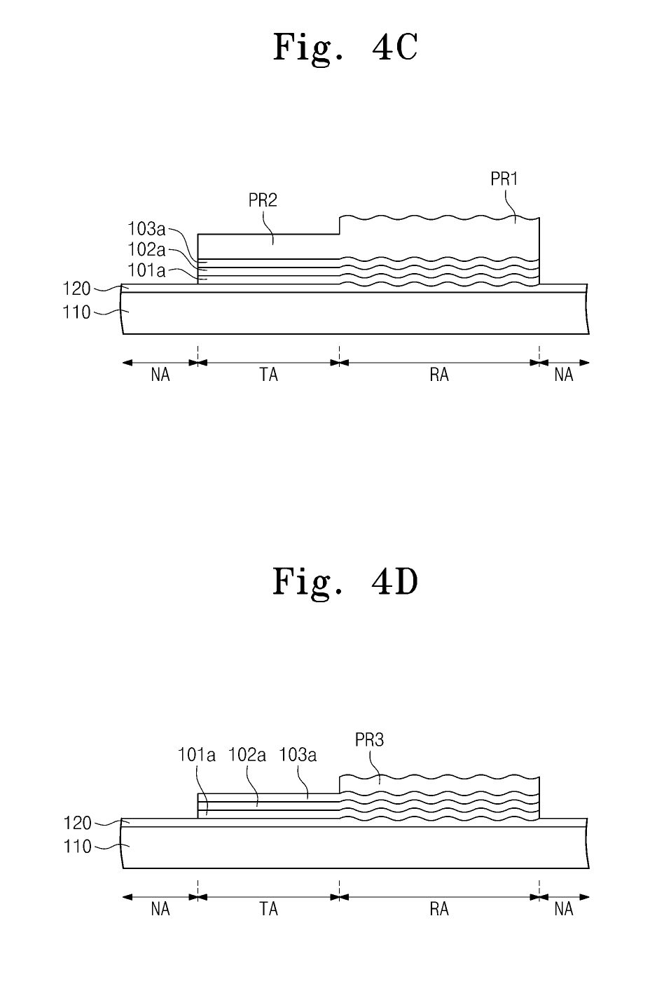

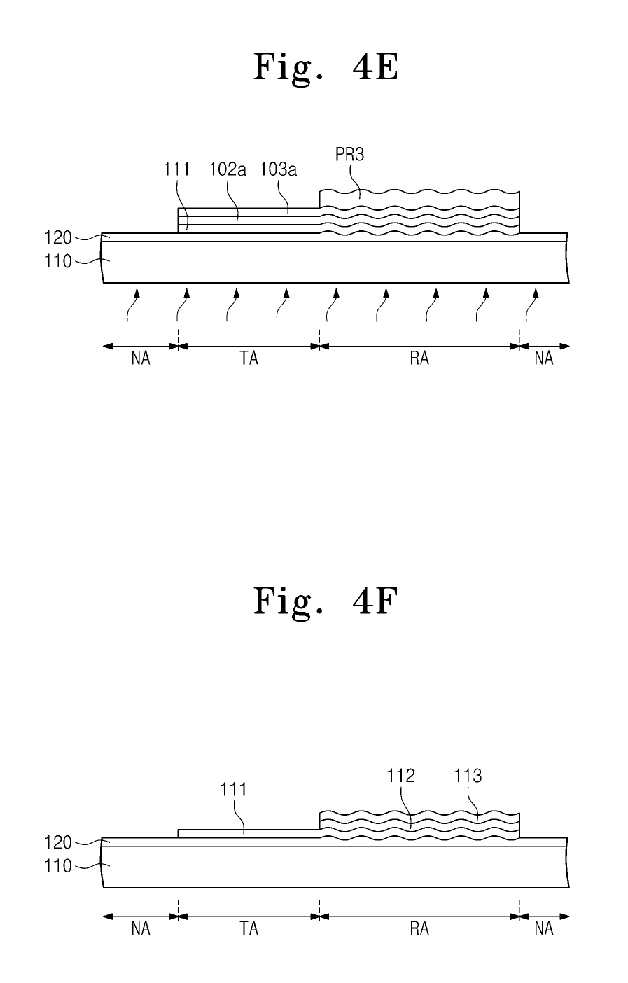

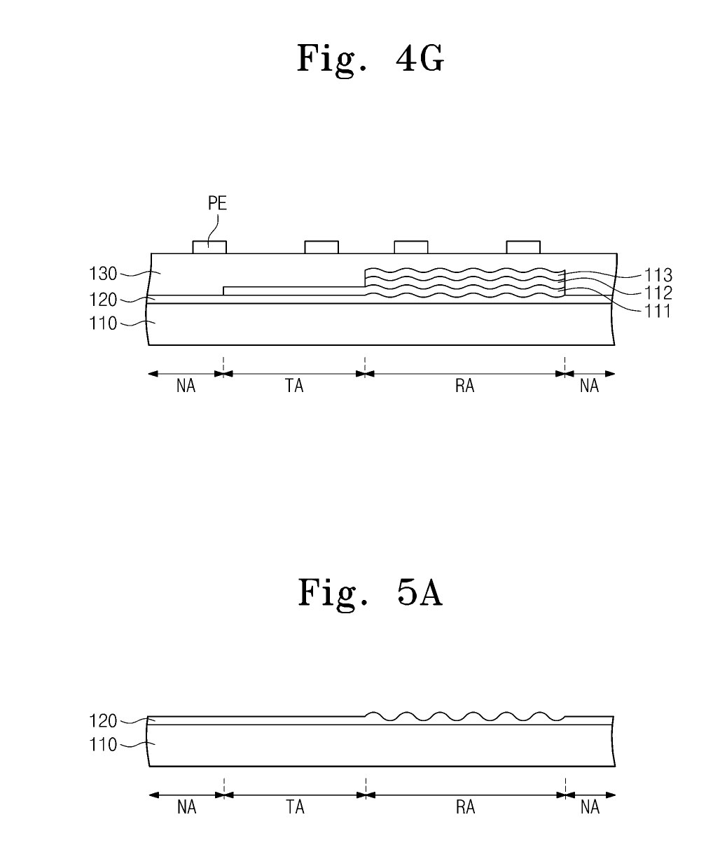

FIGS. 4A to 4G are cross-sectional views showing a method of manufacturing a TFT substrate according to an exemplary embodiment of the invention.

Referring to FIG. 4A, the first substrate 110 including the transparent insulating material is prepared. The first substrate 110 includes the transmissive area TA, the reflective area RA and a non-display area NA. The non-display area NA corresponds to an area outside of the pixel and the image is not displayed in the non-display area NA.

The gate line, the data line and the TFT are disposed on the first substrate 110. For the convenience of explanation, detailed descriptions of processes used to provide the gate line, the data line and the TFT will be omitted.

An organic insulating material is deposited on the entire surface of the first substrate 110. Then, the concavo-convex portions are disposed on the upper surface of the organic insulating material overlapped with the reflective area RA by using a photolithography process. In this case, the average thickness of the concavo-convex portions is equal to the thickness of the organic insulating material deposited to overlap with the transmissive area TA. Therefore, the organic insulating layer 120 is provided such that the upper surface thereof has the concavo-convex shape which overlaps with the reflective area RA.

Referring to FIG. 4B, a first transparent conductive layer 101, a metal material layer 102, and a second transparent conductive layer 103 are sequentially disposed on the organic insulating layer 120. In this case, the first transparent conductive layer 101, the metal material layer 102, and the second transparent conductive layer 103 have the concavo-convex shape corresponding to the concavo-convex portions of the organic insulating layer 120 in the reflective area RA.

The first transparent conductive layer 101 includes a-ITO and the second transparent conductive layer 103 includes a-IZO. The metal material layer 102 includes the metallic material having the high reflectance. In an exemplary embodiment, the metal material layer 102 may include Ag, Al, AlNd, Cr, MoW, or an alloy thereof. In addition, the metal material layer 102 has a single-layer structure or a multi-layer structure. In the exemplary embodiment, the metal material layer 102 includes aluminum (Al), for example.

After that, a photoresist layer PR including a photosensitive material is provided over the first substrate 110, and a light is irradiated onto the photoresist layer PR through a mask MSK.

The mask MSK is a halftone mask, a slit mask, or a diffraction mask and includes a first area R1 to block all the light provided thereto, a second area R2 in which a slit pattern is defined to partially transmit the light provided thereto and to partially block the light provided thereto and a third area R3 to transmit all the light provided thereto. The light transmitting through the mask MSK is irradiated onto the photoresist layer PR. Here, the first area R1 corresponds to the reflective area RA, the second area R2 corresponds to the transmissive area TA, and the third area R3 corresponds to the non-display area NA.

Then, the photoresist layer PR exposed to the light through the mask MSK is developed. As shown in FIG. 4C, a first photoresist layer pattern PR1 and a second photoresist layer pattern PR2, each of which has a predetermined thickness, remain in areas corresponding to the first and second areas R1 and R2 through which the light is blocked or partially transmits. In addition, the photoresist layer PR is completely removed in an area corresponding to the third are R3 that transmits all the light provided thereto, and thus the surface of the organic insulating layer 120 is exposed.

In this case, since the exposure amount of the second area R2 is greater than the exposure amount of the first area R1, the second photoresist layer pattern PR2 has a thickness taken in a vertical direction in a cross section smaller than that of the first photoresist layer pattern R1.

In the exemplary embodiment, the positive photoresist is used to provide the photoresist layer PR such that the exposed portion of the photoresist layer PR is removed, but it should not be limited thereto or thereby. That is, the negative photoresist may be used to provide the photoresist layer PR such that the non-exposed portion of the photoresist layer PR is removed.

Referring to FIG. 4C, when a wet etching process is performed with a first etchant using the first and second photoresist layer patterns PR1 and PR2 as masks, a portion of the first transparent conductive layer 101, a portion of the metal material layer 102 and a portion of the second transparent conductive layer 103, which are not covered by the first and second photoresist patterns PR1 and PR2, are removed. Accordingly, a first transparent conductive layer 101a, a metal material layer 102a and a second transparent layer 103a, each of which is partially removed, are provided.

In this case, the first etchant may have properties to remove the first transparent layer 101, the metal material layer 102 and the second transparent layer 103.

Referring to FIG. 4D, a portion of the first photoresist layer pattern PR1 and the second photoresist layer pattern PR2 are removed by an ashing process or an etchback process, and thus the upper surface of the second transparent conductive layer 103a, which corresponds to the transmissive area TA, is exposed.

In this case, the first photoresist layer pattern PR1 is removed by the thickness of the second photoresist layer pattern PR2 to provide a third photoresist pattern PR3. As a result, the third photoresist layer pattern PR3 remains only in the reflective area RA, so that the upper surface of the second transparent conductive layer 103a, which corresponds to the reflective area RA, is covered by the third photoresist layer pattern PR3.

Referring to FIG. 4E, when an annealing process is performed to crystallize the material used to provide the first transparent conductive layer 101a, a crystallization layer 111 is provided. The a-ITO used to provide the first transparent conductive layer 101a is crystallized by the annealing process, and thus the p-ITO for the crystallization layer 111 is provided. To crystallize the a-ITO, the annealing process is performed at a temperature of about 150 degrees Celsius (° C.) or more. In an exemplary embodiment, the annealing process may be performed using a rapid thermal annealing (“RTA”) process, a flash lamp annealing process, a laser annealing process, etc.

Referring to FIG. 4F, when a wet etching process is performed with the first etchant using the third photoresist layer pattern PR3 as a mask, the metal material layer 102a and the second transparent conductive layer 103a which are not covered by the third photoresist layer pattern PR3 are removed. In this case, the crystallization layer 111 is not removed. The first etchant is the same as the etchant used to perform the process described with reference to FIG. 4C. The first etchant does not etch the crystallization layer 111 and etches the metal material layer 102a and the second transparent conductive layer 103a. In detail, the first etchant etches a-ITO and Ag and does not etch p-ITO. Thus, the metal layer 112 and the upper electrode 113 are provided.

As a result, the common electrode and the reflective portion are provided. The common electrode is defined by the crystallization layer 111 overlapped with the transmissive area TA. The reflective portion is defined by the crystallization layer 111, the metal layer 112 and the upper electrode 113, which are overlapped with the reflective area RA. Then, the third photoresist layer pattern PR3 is removed.

Referring to FIG. 4G, the insulating material is deposited on the first substrate 110, on which the upper electrode 113 is provided, to provide the passivation layer 130. Then, the pixel electrode PE is disposed on the passivation layer 130 by using a photolithography process.

According to the manufacturing method of the TFT substrate, the common electrode and the reflective portion may be provided using one mask. Therefore, the number of the masks required to manufacture the TFT substrate may be effectively reduced and a manufacturing cost of the TFT substrate may be effectively reduced.

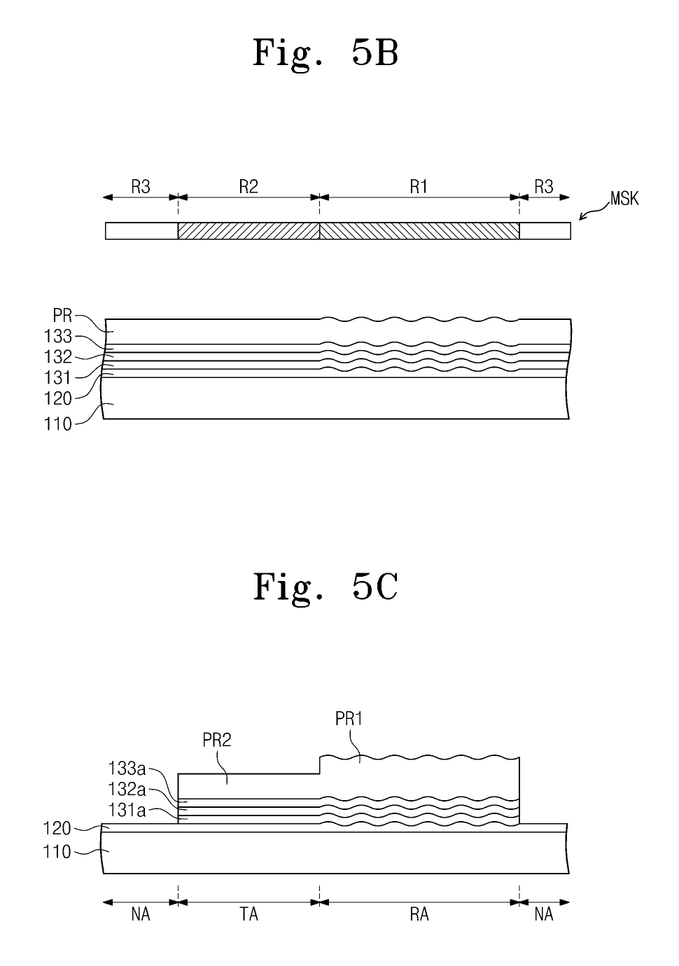

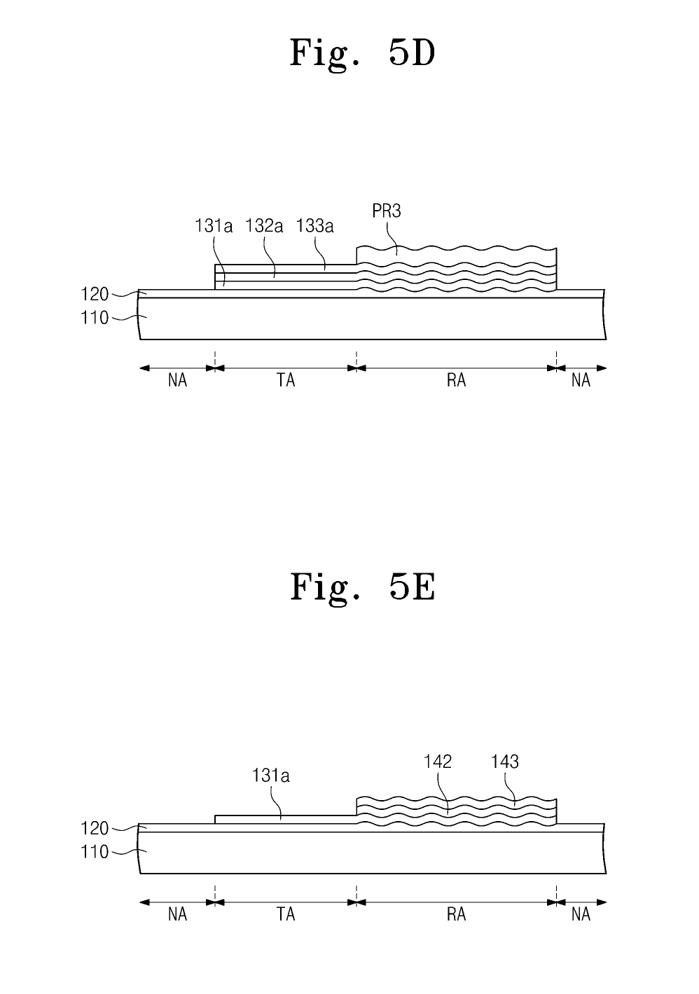

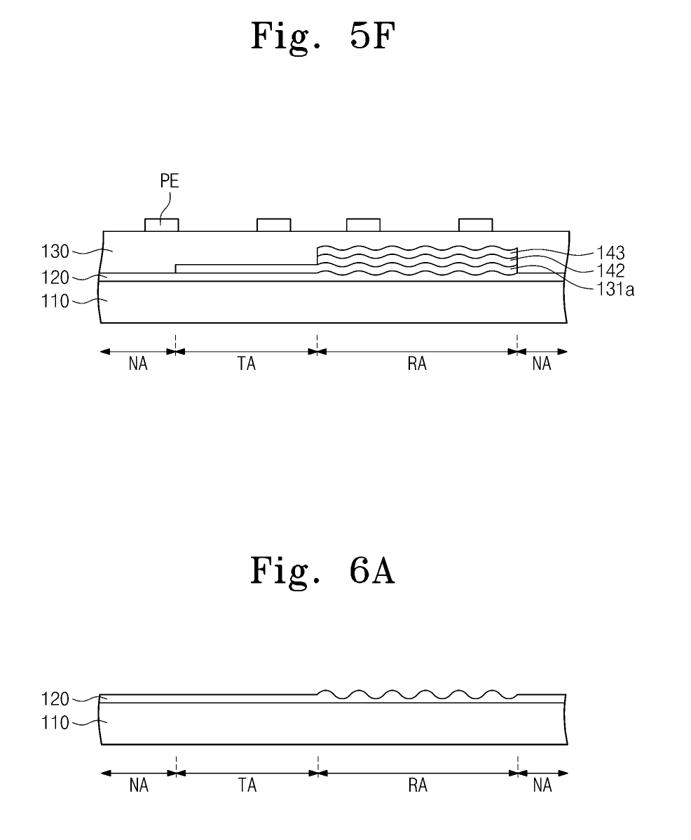

FIGS. 5A to 5F are cross-sectional views showing a method of manufacturing a TFT substrate according to another exemplary embodiment of the invention.

Referring to FIG. 5A, the first substrate 110 including the transparent insulating material is prepared. The first substrate 110 includes the transmissive area TA, the reflective area RA and a non-display area NA.

The gate line, the data line and the TFT are disposed on the first substrate 110. For the convenience of explanation, detailed descriptions of processes used to provide the gate line, the data line, and the TFT will be omitted.

An organic insulating material is deposited on the entire surface of the first substrate 110. Then, the concavo-convex portions are disposed on the upper surface of the organic insulating material overlapped with the reflective area RA by using a photolithography process. In this case, the average thickness of the concavo-convex portions is equal to the thickness of the organic insulating material deposited to overlap with the transmissive area TA. Therefore, the organic insulating layer 120 is provided such that the upper surface thereof has the concavo-convex shape to overlap with the reflective area RA.

Referring to FIG. 5B, a first transparent conductive layer 131 is deposited on the entire surface of the organic insulating layer 120. The first transparent conductive layer 131 is provided by depositing a-ITO at a temperature of about 140° C. or more. The a-ITO is crystallized at the temperature of about 150° C. or more, and thus the first transparent conductive layer 131 includes p-ITO. The first transparent conductive layer 131 has a thickness of about 1000 angstroms (Å) or more.

Then, a metal material layer 132 and a second transparent conductive layer 133 are sequentially disposed on the first transparent conductive layer 131. In this case, the first transparent conductive layer 131, the metal material layer 132, and the second transparent conductive layer 133 have the concavo-convex shape corresponding to the concavo-convex portions of the organic insulating layer 120 in the reflective area RA.

In an exemplary embodiment, the second transparent conductive layer 133 includes a-ITO or a-IZO, for example.

The metal material layer 132 includes the metallic material having the high reflectance. In an exemplary embodiment, the metal material layer 132 may include Ag, Al, AlNd, Cr, MoW, or an alloy thereof. In addition, the metal material layer 132 has a single-layer structure or a multi-layer structure. In the exemplary embodiment, the metal material layer 132 includes aluminum (Al), for example.

A photoresist layer PR including a photosensitive material is provided over the first substrate 110, and a light is irradiated onto the photoresist layer PR through a mask MSK.

The mask MSK is a halftone mask, a slit mask, or a diffraction mask and includes a first area R1 to block all the light provided thereto, a second area R2, to which a slit pattern is applied, to partially transmit the light provided thereto and to partially block the light provided thereto and a third area R3 to transmit all the light provided thereto. The light transmitting through the mask MSK is irradiated onto the photoresist layer PR. Here, the first area R1 corresponds to the reflective area RA, the second area R2 corresponds to the transmissive area TA and the third area R3 corresponds to the non-display area NA.

Then, the photoresist layer PR exposed to the light through the mask MSK is developed. As shown in FIG. 5C, a first photoresist layer pattern PR1 and a second photoresist layer pattern PR2, each of which has a predetermined thickness, remain in areas corresponding to the first and second areas R1 and R2 through which the light is blocked or partially transmits. In addition, the photoresist layer PR is completely removed in an area corresponding to the third are R3 that transmits all the light provided thereto, and thus the surface of the second transparent conductive layer 133 is exposed.

In this case, since the exposure amount of the second area R2 is greater than the exposure amount of the first area R1, the second photoresist layer pattern PR2 has a thickness smaller than that of the first photoresist layer pattern PR1.

Referring to FIG. 5C, when a wet etching process is performed with a first etchant using the first and second photoresist layer patterns PR1 and PR2 as masks, a portion of the first transparent conductive layer 131, a portion of the metal material layer 132, and a portion of the second transparent conductive layer 133, which are not covered by the first and second photoresist patterns PR1 and PR2, are removed. Accordingly, a first transparent conductive layer 131a, a metal material layer 132a, and a second transparent layer 133a, each of which is partially removed, are provided.

In this case, the first etchant may have properties to remove the first transparent layer 131, the metal material layer 132 and the second transparent layer 133.

Referring to FIG. 5D, a portion of the first photoresist layer pattern PR1 and the second photoresist layer pattern PR2 are removed by an ashing process or an etchback process, and thus the upper surface of the second transparent conductive layer 133a, which corresponds to the transmissive area TA, is exposed.

In this case, the first photoresist layer pattern PR1 is removed by the thickness of the second photoresist layer pattern PR2 to provide a third photoresist pattern PR3. As a result, the third photoresist layer pattern PR3 remains only in the reflective area RA, so that the upper surface of the second transparent conductive layer 133a, which corresponds to the reflective area RA, is covered by the third photoresist layer pattern PR3.

Referring to FIG. 5E, a wet etching process is performed with a second etchant using the third photoresist layer pattern PR3 to remove the metal material layer 132a and the second transparent conductive layer 133a, which are not covered by the third photoresist layer pattern PR3. In this case, the first transparent conductive layer 131a is not etched. The second etchant is different from the first etchant used to perform the process described with reference to FIG. 5C. The first etchant etches the first transparent conductive layer 131a, the metal material layer 132a and the second transparent conductive layer 133a, but the second etchant etches only the metal material layer 132a and the second transparent conductive layer 133a. In detail, the first etchant etches p-ITO, a-ITO (or a-IZO), and Ag, and the second etchant etches a-ITO (or a-IZO) and Ag. Thus, the metal layer 142 and the upper electrode 143 are provided.

As a result, the common electrode and the reflective portion are provided. The common electrode is defined by the first transparent conductive layer 131a overlapped with the transmissive area TA. The reflective portion is defined by the first transparent conductive layer 131a, the metal layer 142 and the upper electrode 143, which are overlapped with the reflective area RA. Then, the third photoresist layer pattern PR3 is removed.

Referring to FIG. 5F, the insulating material is deposited on the first substrate 110, on which the upper electrode 143 is provided, to provide the passivation layer 130. Then, the pixel electrode PE is disposed on the passivation layer 130 by using a photolithography process.

According to the manufacturing method of the TFT substrate, the common electrode and the reflective portion may be provided using one mask. Therefore, the number of the masks required to manufacture the TFT substrate may be effectively reduced and a manufacturing cost of the TFT substrate may be effectively reduced. In addition, the annealing process described with reference to FIGS. 4A to 4G is not needed anymore in the exemplary embodiment.

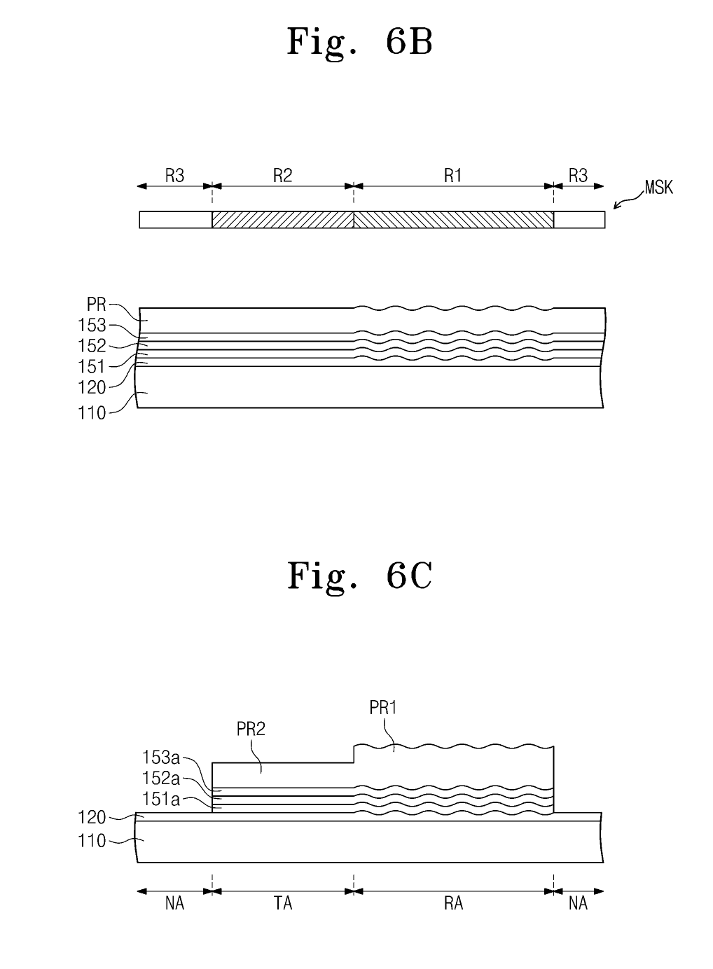

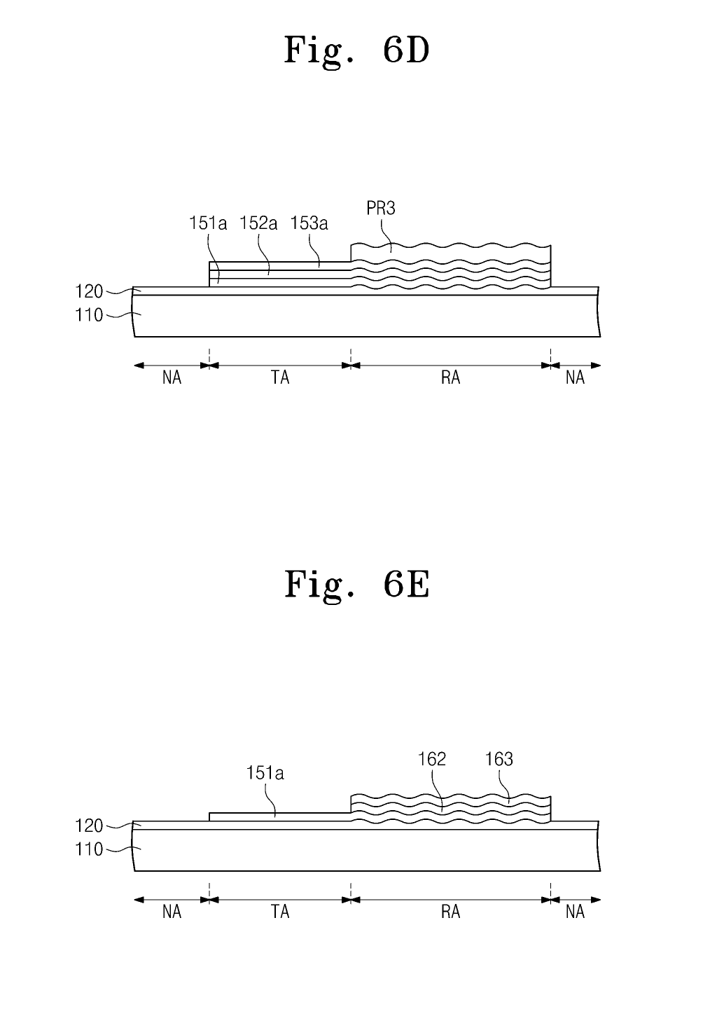

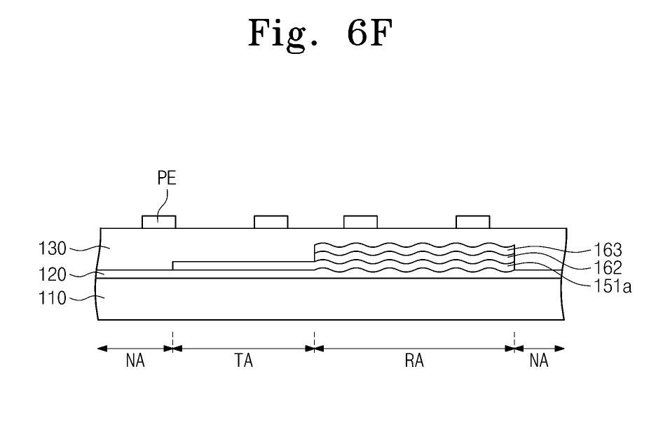

FIGS. 6A to 6F are cross-sectional views showing a method of manufacturing a TFT substrate according to another exemplary embodiment of the invention.

Referring to FIG. 6A, the first substrate 110 including the transparent insulating material is prepared. The first substrate 110 includes the transmissive area TA, the reflective area RA and a non-display area NA.

The gate line, the data line and the TFT are disposed on the first substrate 110. For the convenience of explanation, detailed descriptions of processes used to provide the gate line, the data line, and the TFT will be omitted.

An organic insulating material is deposited on the entire surface of the first substrate 110. Then, the concavo-convex portions are disposed on the upper surface of the organic insulating material overlapped with the reflective area RA by using a photolithography process. In this case, the average thickness of the concavo-convex portions is equal to the thickness of the organic insulating material deposited to overlap with the transmissive area TA. Therefore, the organic insulating layer 120 is provided such that the upper surface thereof has the concavo-convex shape to overlap with the reflective area RA.

Referring to FIG. 6B, a first transparent conductive layer 151, a metal material layer 152 and a second transparent conductive layer 153 are sequentially disposed on the organic insulating layer 120. In this case, the first transparent conductive layer 151, the metal material layer 152 and the second transparent conductive layer 153 have the concavo-convex shape corresponding to the concavo-convex portions of the organic insulating layer 120 in the reflective area RA.

The first transparent conductive layer 151 includes a-ITO and the second transparent conductive layer 153 includes a-IZO. The metal material layer 152 includes the metallic material having the high reflectance. In an exemplary embodiment, the metal material layer 152 may include Ag, Al, AlNd, Cr, MoW, or an alloy thereof. In addition, the metal material layer 152 has a single-layer structure or a multi-layer structure. In the exemplary embodiment, the metal material layer 152 includes aluminum (Al), for example.

After that, a photoresist layer PR including a photosensitive material is provided over the first substrate 110, and a light is irradiated onto the photoresist layer PR through a mask MSK.

The mask MSK is a halftone mask, a slit mask, or a diffraction mask and includes a first area R1 to block all the light provided thereto, a second area R2, to which a slit pattern is applied, to partially transmit the light provided thereto and to partially block the light provided thereto and a third area R3 to transmit all the light provided thereto. The light transmitting through the mask MSK is irradiated onto the photoresist layer PR. Here, the first area R1 corresponds to the reflective area RA, the second area R2 corresponds to the transmissive area TA, and the third area R3 corresponds to the non-display area NA.

Then, the photoresist layer PR exposed to the light through the mask MSK is developed. As shown in FIG. 6C, a first photoresist layer pattern PR1 and a second photoresist layer pattern PR2, each of which has a predetermined thickness, remain in areas corresponding to the first and second areas R1 and R2 through which the light is blocked or partially transmits. In addition, the photoresist layer PR is completely removed in an area corresponding to the third are R3 that transmits all the light provided thereto, and thus the surface of the organic insulating layer 120 is exposed.

In this case, since the exposure amount of the second area R2 is greater than the exposure amount of the first area R1, the second photoresist layer pattern PR2 has a thickness smaller than that of the first photoresist layer pattern PR1.

Referring to FIG. 6C, when a wet etching process is performed with a first etchant using the first and second photoresist layer patterns PR1 and PR2 as masks, a portion of the first transparent conductive layer 151, a portion of the metal material layer 152 and a portion of the second transparent conductive layer 153, which are not covered by the first and second photoresist patterns PR1 and PR2, are removed. Accordingly, a first transparent conductive layer 151a, a metal material layer 152a and a second transparent layer 153a, each of which is partially removed, are provided.

In this case, the first etchant may have properties to remove the first transparent layer 151, the metal material layer 152 and the second transparent layer 153.

Referring to FIG. 6D, a portion of the first photoresist layer pattern PR1 and the second photoresist layer pattern PR2 are removed by an ashing process or an etchback process, and thus the upper surface of the second transparent conductive layer 153a, which corresponds to the transmissive area TA, is exposed.

In this case, the first photoresist layer pattern PR1 is removed by the thickness of the second photoresist layer pattern PR2 to provide a third photoresist pattern PR3. As a result, the third photoresist layer pattern PR3 remains only in the reflective area RA, so that the upper surface of the second transparent conductive layer 153a, which corresponds to the reflective area RA, is covered by the third photoresist layer pattern PR3.

Referring to FIG. 6E, a wet etching process is performed with a second etchant using the third photoresist layer pattern PR3 to remove the metal material layer 152a and the second transparent conductive layer 153a, which are not covered by the third photoresist layer pattern PR3. In this case, the first transparent conductive layer 151a is not etched. The second etchant is different from the first etchant used to perform the process described with reference to FIG. 6C. The first etchant etches the first transparent conductive layer 151a, the metal material layer 152a and the second transparent conductive layer 153a, but the second etchant etches only the metal material layer 152a and the second transparent conductive layer 153a. In detail, the first etchant etches a-ITO, a-IZO and Ag, and the second etchant etches a-IZO and Ag. Thus, the metal layer 162 and the upper electrode 163 are provided. As a result, the common electrode and the reflective portion are provided. The common electrode is defined by the first transparent conductive layer 151a overlapped with the transmissive area TA. The reflective portion is defined by the first transparent conductive layer 151a, the metal layer 162 and the upper electrode 163, which are overlapped with the reflective area RA. Then, the third photoresist layer pattern PR3 is removed.

Referring to FIG. 6F, the insulating material is deposited on the first substrate 110, on which the upper electrode 163 is provided, to provide the passivation layer 130. Then, the pixel electrode PE is disposed on the passivation layer 130 by using a photolithography process.

According to the manufacturing method of the TFT substrate, the common electrode and the reflective portion may be provided using one mask. Therefore, the number of the masks required to manufacture the TFT substrate may be effectively reduced and a manufacturing cost of the TFT substrate may be effectively reduced. In addition, the annealing process described with reference to FIGS. 4A to 4G is not needed anymore in the exemplary embodiment.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A thin film transistor substrate comprising:
a first substrate which includes a transmissive area and a reflective area;
a common electrode disposed on the first substrate;
a pixel electrode overlapped with and insulated from the common electrode; and
a reflective portion which is disposed on the reflective area and comprises:
a lower electrode which includes a first transparent conductive material;
a metal layer disposed on the lower electrode; and
an upper electrode disposed on the metal layer and including a second transparent conductive material different from the first transparent conductive material.

2. The thin film transistor substrate of claim 1, further comprising an organic insulating layer disposed between the first substrate and the reflective portion, and between the first substrate and the common electrode,
wherein an upper surface of the organic insulating layer has a concavo-concave shape in an area in which the organic insulating layer is overlapped with the reflective area.

3. The thin film transistor substrate of claim 2, wherein a thickness of the organic insulating layer in an area other than the area in which the organic insulating layer is overlapped with the reflective area, is equal to an average thickness of the organic insulating layer in the area in which the organic insulating layer is overlapped with the reflective area.

4. The thin film transistor substrate of claim 2, wherein each of the lower electrode, the metal layer and the upper electrode has a concavo-concave shape corresponding to and substantially the same as the concavo-concave shape of the upper surface of the organic insulating layer.

5. The thin film transistor substrate of claim 1, wherein
the first transparent conductive material comprises a material comprising polycrystalline indium tin oxide, amorphous indium tin oxide, polycrystalline indium zinc oxide or amorphous indium zinc oxide, and
the second transparent conductive material comprises a material comprising polycrystalline indium tin oxide, amorphous indium tin oxide, polycrystalline indium zinc oxide or amorphous indium zinc oxide except for the one material used to provide the first transparent conductive material.

6. The thin film transistor substrate of claim 1, wherein the metal layer comprises silver, aluminum, AlNd, Chromium, MoW, or an alloy thereof.

7. The thin film transistor substrate of claim 1, wherein
the first substrate transmits a light provided to the first substrate from a lower portion of the first substrate in the transmissive area, to an upper portion of the first substrate, and
the first substrate reflects an external light provided to the first substrate from the upper portion of the first substrate in the reflective area, to the upper portion of the first substrate.

8. A display device comprising:
a thin film transistor substrate;
an opposite substrate facing the thin film transistor substrate; and
a liquid crystal layer disposed between the thin film transistor substrate and the opposite substrate, the thin film transistor substrate comprising:
a first substrate which includes a transmissive area and a reflective area;
a common electrode disposed on the first substrate;
a pixel electrode overlapped with and insulated from the common electrode; and
a reflective portion which is disposed on the reflective area and comprises:
a lower electrode which includes a first transparent conductive material;
a metal layer disposed on the lower electrode; and
an upper electrode disposed on the metal layer and including a second transparent conductive material different from the first transparent conductive material.

9. The display device of claim 8, wherein the opposite substrate comprises:
a second substrate;
a black matrix disposed on the second substrate;
a color filter layer disposed on the black matrix; and
an overcoating layer which is disposed on the color filter layer and overlaps with the reflective area.

10. A method of manufacturing a thin film transistor substrate, the method comprising:
providing a first substrate including a transmissive area and a reflective area;
disposing an organic insulating layer on the first substrate;
providing a reflective portion and a first electrode on the organic insulating layer using one mask; and
providing a second electrode insulated from the first electrode.

11. The method of claim 10, wherein the forming the organic insulating layer comprises:
depositing an organic insulating material on the first substrate; and
defining a concavo-concave shape on an upper surface of the organic insulating material overlapped with the reflective area.

12. The method of claim 11, wherein an average thickness of the organic insulating material having the concavo-concave shape is equal to a thickness of the organic insulating material overlapped with the transmissive area.

13. The method of claim 11, wherein the forming the reflective portion and the first electrode comprises:
depositing a first transparent conductive layer on the organic insulating layer;
depositing a metal material layer on the first transparent conductive layer;
depositing a second transparent conductive layer on the metal material layer; and
patterning the first transparent conductive layer, the metal material layer and the second transparent conductive layer using a halftone mask, a slit mask, or a diffraction mask, which is disposed above on the second transparent conductive layer.

14. The method of claim 13, wherein the metal material layer comprises silver, aluminum, AlNd, Chromium, MoW, or an alloy thereof.

15. The method of claim 13, wherein the patterning the first transparent conductive layer, the metal material layer, and the second transparent conductive layer comprises:
disposing a photoresist layer on the second transparent conductive layer;
exposing and developing the photoresist layer using the halftone mask, the slit mask, or the diffraction mask to provide a first photoresist layer pattern overlapped with the reflective area and a second photoresist layer pattern overlapped with the transmissive area;
etching the first transparent conductive layer, the metal material layer and the second transparent conductive layer, which are not covered by the first and second photoresist layer patterns, with a first etchant using the first and second photoresist layer patterns as masks;
removing the second photoresist layer pattern and a portion of the first photoresist layer pattern to provide a third photoresist layer pattern;
crystallizing the first transparent conductive layer to provide a crystallization layer; and
etching the metal material layer and the second transparent conductive layer, which are not covered by the third photoresist layer pattern, with the first etchant using the third photoresist layer pattern as a mask.

16. The method of claim 15, wherein
the first transparent conductive layer includes amorphous indium tin oxide, and
the second transparent conductive layer includes amorphous indium zinc oxide.

17. The method of claim 16, wherein the first etchant etches materials used to respectively provide the first transparent conductive layer, the metal material layer and the second transparent conductive layer other than a material used to provide the crystallization layer.

18. The method of claim 13, wherein the patterning the first transparent conductive layer, the metal material layer, and the second transparent conductive layer comprises:
disposing a photoresist layer on the second transparent conductive layer;
exposing and developing the photoresist layer using the halftone mask, the slit mask, or the diffraction mask to provide a first photoresist layer pattern overlapped with the reflective area and a second photoresist layer pattern overlapped with the transmissive area;
etching the first transparent conductive layer, the metal material layer and the second transparent conductive layer, which are not covered by the first and second photoresist layer patterns, with a first etchant using the first and second photoresist layer patterns as masks;
removing the second photoresist layer pattern and a portion of the first photoresist layer pattern to provide a third photoresist layer pattern; and
etching the metal material layer and the second transparent conductive layer, which are not covered by the third photoresist layer pattern, with a second etchant different from the first etchant using the third photoresist layer pattern as a mask.

19. The method of claim 18, wherein the first transparent conductive layer is provided by depositing amorphous indium tin oxide at a temperature of about 150 degrees Celsius or more.

20. The method of claim 19, wherein the first transparent conductive layer includes crystalline indium tin oxide, and the second transparent conductive layer includes amorphous indium zinc oxide or amorphous indium tin oxide.

21. The method of claim 20, wherein
the first etchant etches materials used to respectively provide the first transparent conductive layer, the metal material layer and the second transparent conductive layer, and
the second etchant etches materials used to respectively provide the second transparent conductive layer and the metal material layer other than a material used to provide the first transparent conductive layer.

22. The method of claim 18, wherein
the first transparent conductive layer includes amorphous indium tin oxide and
the second transparent conductive layer includes amorphous indium zinc oxide.

23. The method of claim 22, wherein
the first etchant etches materials used to respectively provide the first transparent conductive layer, the metal material layer and the second transparent conductive layer, and
the second etchant etches materials used to respectively provide the second transparent conductive layer and the metal material layer and does not etch a material used to provide the first transparent conductive layer.
